(19) United States
(12) Patent Application Publication
(10) Pub. No.: US 2025/0155066 A1
(43) Pub. Date: May 15, 2025

(54) SYSTEMS AND METHODS FOR SUPPRESSING TURBULENCE IN PIPE AND CHANNEL FLOWS

(71) Applicant: MASSACHUSETTS INSTITUTE OF TECHNOLOGY, Cambridge, MA (US)

(72) Inventors: Justin Douglas BEROZ, Cambridge, MA (US); John W. M. BUSH, Cambridge, MA (US)

(21) Appl. No.: 18/839,997

(22) PCT Filed: Mar. 2, 2023
(86) PCT No.: PCT/US2023/014382

§ 371 Date: Aug. 20, 2024

Related U.S. Application Data
(60) Provisional application No. 63/315,835, filed on Mar. 2, 2022.

(51) Int. Cl. F16L 55/02; F15D 1/00; F15D 1/06

(52) U.S. Cl. CPC F16L 55/02; F15D 1/007; F15D 1/06

(57) ABSTRACT

Systems and methods for active and passive suppression of the transition from laminar to turbulent fluid flow in conduits for fluid transport, which include pipes, channels, and semi-confined passageways. Examples include implementations of a turbulence model that predicts a turbulence transition mode of a fluid within the conduit and systems and methods for modifying the fluid in the conduit to reduce or suppress the predicted turbulence transition mode and thereby prevent or delay transition of the fluid flow from laminar to turbulent. Examples include active and systems to introduce disturbances into the fluid flow that cancel, absorb, or reduce the predicted turbulence transition mode. Examples include conduit liners configured to absorb energy from the fluid flow at a frequency of the predicted turbulence transition mode. Examples include textures and surface geometries configured to transfer energy in the fluid flow from the predicted turbulence transition mode to a different frequency.

### CROSS-REFERENCE TO RELATED APPLICATIONS

This application claims priority to and the benefit of U.S. Provisional Application Ser. No. 63/315,835, entitled “TURBULENCE SUPPRESSION METHODS AND DEVICES FOR PIPE AND CHANNEL FLOW,” and filed Mar. 2, 2022, the content of which is incorporated by reference herein in its entirety.

### GOVERNMENT RIGHTS

This invention was made with government support under CMMII727565 awarded by the National Science Foundation. The government has certain rights in the invention.

### FIELD

The following disclosure relates to methods and systems for active and passive suppression of the transition from laminar to turbulent fluid flow in conduits, which are defined broadly as any confined or semi-confined passageway for fluid transport, such as pipes of circular, or other, cross-sectional geometry, as well as channels of both the open and closed type.

### BACKGROUND

The engineering of pipes and conduits for the transportation of liquids over long distances is a subject nearly as old as human civilization, with evidence dating into antiquity through historical records of water supply routes, water clocks, and water organs. Some of the earliest known measurements of fluid flow characteristics through conduits date back to the construction of water art gardens in Versailles during the late seventeenth century, and since then, steady progress has been made refining empirical observations and theoretical understanding of such flows.

It is now known that fluids may flow through a conduit in two ways: laminar or turbulent. At small flow rates, the flow is laminar and characterized by an ordered velocity field aligned with the direction of flow. As the flow rate increases, the flow abruptly becomes chaotic and complex, which marks the transition to turbulence and turbulent flow. Turbulence, and turbulent flow, is then found for all higher flow rates. The scientific effort to model and understand this phenomenon began in earnest with the pipe flow experiments of Osborne Reynolds in the 1880s, although closely related work had been accumulating over the previous century. A complete understanding of the development of turbulent flow in pipes, however, has remained elusive to this day. Termed “the turbulence problem” in 1921, it is one of the oldest unresolved problem in classical physics and still an active area of research.

The turbulence transition in pipe flow is of great practical importance because it coincides with an abrupt increase in flow resistance through the pipe by approximately ten times compared to laminar flow, and the required pumping energy (as well as the stress on the pump) increases by the same factor. Finding a method to effectively control or delay the turbulence transition has been a “holy grail” in fluid engineering, alongside solving the turbulence problem in physics. Technical advances, however, have been small and incremental (e.g., minimizing pipe surface roughness, improving pipe segment alignment, etc.). This lack of substantial advancement is largely attributable to a limited practical understanding of the turbulence transition, which ultimately stems from the incomplete physical theory. In particular, the precise flow rate at which the transition occurs can vary by orders of magnitude and is highly sensitive to many factors pertaining the pipe and its environment, including external disturbances, pipe shape and surface finish, properties of the fluid, and more. A large body of intellectual property exists aimed at mitigating the development of turbulence in conduit flow, however, all known prior work fundamentally originates from empirical observations and intuition rather than insights rooted in an exact and complete theoretical framework.

Today, in practice, nearly all industrial-scale pipe flows operate far above the turbulence transition. The reason for this operation is two-fold. First, laminar flow rates are often impractically slow. Second, flow rates near the transition can cause intermittent transitions between laminar and turbulent flow, which exert large cyclic stresses on the pipe wall that drastically reduce the structural integrity of the pipe over time. The implication is a cost trade-off between balancing the rate of product delivery through the pipe against expenses for installation, energy consumption, and repair. For virtually all industrial piping applications worldwide, the optimal-cost solution is to operate far into the turbulent regime. Consequently, and globally, pipe systems operate at approximately <10% energy efficiency compared to laminar flow at the same flow rates, and collectively account for approximately 2% of world energy consumption.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

Certain aspects of the disclosure provide for a turbulence control system for a pipe or conduit, including one or more modifications of the pipe or channel selected from the group that includes vibration-inducing devices, textured surfaces, modified cross-sections, or cross-sectional structures of the pipe or channel liners, coatings and surface finishes, and conduit flexibility/deformation. In one embodiment, the one or more modifications of the pipe or channel are installed in a manner that suppresses a turbulence transition mode of a fluid or gas within the pipe or conduit.

Example turbulence control systems of the present disclosure include vibration-inducing devices that are mounted to an interior or exterior surfaces of a conduit or pipe, or within the thickness of a wall of the pipe or conduit to impart perturbations to the fluid or gas within the pipe or channel. In some examples, the specific textures/patterns are placed on interior surfaces of the pipe or channel. In some examples, a modification(s) alters the streamwise wavelength and/or cross-section of the pipe or channel so that the pipe or channel is incommensurate with developing the transition mode. The modification can include vibration-absorbing materials lining the interior of the pipe or channel. In some examples, one or more coatings and/or surface finishes are applied to the interior of the pipe. Examples include conduit flexibility/deformation of the pipe channel, or material therein, that are configured to absorb energy from the turbulence transition mode.

In some examples, the turbulence control system includes an inspection gauge for the pipe or channel, where the pipeline inspection gauge is sent through the pipe or channel regularly for cleaning and inspection. In one embodiment, the inspection gauge is configured to travel through existing pipelines and retrofit them from the interior for turbulence suppression. The turbulence control system can include inspection tools configured to travel the interior or exterior of a pipe or channel for cleaning, inspection, and/or repair. In some examples, the inspection tools are configured to retrofit existing pipelines or channel lines for turbulence suppression. The turbulence control system can include manufacture of new pipes or channels integrated with turbulence suppression technology. In some examples, the turbulence control system further includes on-construction-site modifications/retrofits of the pipe or channel for turbulence suppression

One example of the present disclosure is a system for controlling turbulence in a fluid flow in a conduit, the system including a conduit configured to have therein a fluid flow and at least one device associated or integrated with the conduit and configured to generate a disturbance in a fluid flow in the conduit to suppress a calculated turbulence transition mode of the fluid flow. The turbulence transition mode can be calculated based on a turbulence model using a geometry of the conduit and one or more properties of the fluid and further by calculating, according to the turbulence model, at least one response function and an excitement amplitude for each response function. In some examples, the turbulence transition mode was calculated according to Equation 12 and the generated disturbance was calculated as a function of Equation 4. In some examples, the conduit includes a pipe or channel. The at least one device can be an inner surface of the conduit.

In some examples, the at least device includes an active flow disturbance device, the system further including a controller configured to command the active flow disturbance device, where the active flow disturbance device is configured to modify flow parameters of the fluid flow in the conduit in response to the controller, and where the controller is configured to generate commands based on the calculated turbulence transition mode. The system can include at least one sensor configured to measure one or more properties of the fluid flow in the conduit related to the transition between laminar and turbulence flow, where the controller is further configured to generate the commands based on the measured properties. In some examples, the controller is configured to at least one of calculate or adjust the calculation of the turbulence transition mode or an amplification response function for the turbulence transition mode for the fluid flow in the conduit based on the measured properties.

In some examples, the inner surface includes a deformable material configured to absorb energy from the calculated turbulence transition mode in the fluid flow. The at least one device includes a vibration-inducing device arranged to introduce vibrational energy into the fluid flow to suppress the calculated turbulence transition mode

Another example of the present disclosure is a method of controlling fluid flow in a conduit, the method including adjusting a flow of a fluid through a conduit to reduce turbulence therein based on a determined turbulence transition mode. The method can include determining the turbulence transition mode based on a turbulence model as a function of a geometry of the conduit and one or more properties of the fluid and further by calculating, according to the turbulence model, at least one response function and an excitement amplitude for each response function. In some examples, the method includes calculating the turbulence according to Equation 12 and calculating the adjusting of the flow as a function of Equation 4.

In some examples, adjusting the flow of the fluid includes selectively absorbing energy from the fluid at or about the calculated turbulence transition mode of the fluid flow. Adjusting the flow of the fluid can include actuating an active flow control device configured to generate a disturbance in a fluid flow in the conduit to suppress a calculated turbulence transition mode of the fluid flow. The method can include adjusting the flow of the fluid with at least one device associated or integrated with the conduit and where adjusting the flow of the fluid includes introducing to the fluid flow or extracting energy from the fluid flow.

In some examples, the method includes sensing at least one property of the fluid flow in the conduit related to the transition between laminar and turbulence flow; and adjusting the flow of the fluid with the at least one device based on the sensed at least one property. The method can include calculating or adjusting the calculation of the turbulence transition mode for the fluid flow in the conduit based on the sensed at least one property, and where adjusting the flow of the fluid with the at least one device is further based on the calculated or adjusted turbulence transition mode.

In some examples, the method includes modifying the conduit by changing a property of an interior surface of the conduit or associating at least one device with the conduit, the at least one device or modified interior surface being configured to adjust the flow of the fluid in the conduit to suppress a calculated turbulence transition mode of the fluid flow.

Yet another example of the present disclosure is a method of reducing turbulence in a fluid flow in a conduit that includes, given a fluid flow through a conduit, generating a disturbance in the fluid flow in the conduit to suppress a calculated turbulence transition mode of the fluid flow.

The following Detailed Description references the accompanying drawings which form a part this application and which show, by way of illustration, specific example implementations. Other implementations may be made without departing from the scope of the disclosure.

### BRIEF DESCRIPTION OF DRAWINGS

This disclosure will be more fully understood from the following detailed description taken in conjunction with the accompanying drawings, in which:

FIG. 1 is a graph of the turbulent kinetic energy spectrum E (k) vs. the wave number of the turbulent fluctuation, according to aspects of the presently disclosed theoretical model of fluid turbulence.

FIG. 2 is a graph of the turbulent kinetic energy spectrum E (k) vs. the wave number of the turbulent fluctuation for high-speed turbulent air flow through a circular pipe, where the data markers are historical experimental measurements, and the solid line is representative of the presently disclosed theoretical model of fluid turbulence.

FIG. 3A is a graph of normalized flow disturbance velocity vs. Reynolds number for seminal prior experimental research into turbulence transitions in pipe flow;

FIG. 3B is a re-scaled graph of the prior experimental data of FIG. 3A according to the new turbulence transition model of the present disclosure;

FIG. 4 is a schematic cross-sectional view of a turbulence testing apparatus according to examples of the present disclosure;

FIG. 5 is a transparent perspective view of a pipe including an active turbulence control system example of the present disclosure;

FIG. 6 is a transparent perspective view of a pipe having a passive turbulence control system example of the present disclosure;

FIG. 7 is a transparent perspective view of a pipe having a reactive turbulence control system example of the present disclosure;

FIGS. 8A and 8B are schematic perspective and front views of a conduit having a plurality of passive turbulence control structures disclosed on an inner surface of the conduit;

FIG. 9 is a schematic front cross-sectional view of a conduit having an example active turbulence control system;

FIG. 10 is a schematic side cross-sectional view of a conduit having another example conduit having active turbulence control system;

FIG. 11 is a schematic side cross-sectional view of a conduit with a remote device traveling therein that is modifying an inner surface of the conduit to include active turbulence control devices and fluid property sensors.

FIG. 12 is a perspective illustration of pipe flow showing some of the key terms and conventions used for the turbulence model;

FIG. 13 is a perspective illustration of channel flow showing some of the key terms and conventions used for the turbulence model; and

FIG. 14 is a block diagram of one exemplary embodiment of a computer system for use in conjunction with the present disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-numbered components and/or like-named components of various embodiments generally have similar features when those components are of a similar nature and/or serve a similar purpose, unless otherwise noted or otherwise understood by a person skilled in the art.

The figures provided herein are not necessarily to scale. Still further, to the extent arrows are used to describe a direction of movement, these arrows are illustrative and in no way limit the direction the respective component can or should be moved. A person skilled in the art will recognize other ways and directions for creating the desired result in view of the present disclosure. Additionally, a number of terms may be used throughout the disclosure interchangeably but will be understood by a person skilled in the art.

To the extent the present disclosure includes various terms for components and/or processes of the disclosed devices, systems, aircraft, methods, and the like, one skilled in the art, in view of the claims, present disclosure, and knowledge of the skilled person, will understand such terms are merely examples of such components and/or processes, and other components, designs, processes, and/or actions are possible.

Articles “a” and “an” are used herein to refer to one or to more than one (i.e., at least one) of the grammatical object of the article. By way of example, “an element” means at least one element and can include more than one element. “About” is used to provide flexibility to a numerical range endpoint by providing that a given value may be “slightly above” or “slightly below” the endpoint without affecting the desired result. The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”). Moreover, the present disclosure also contemplates that in some embodiments, any feature or combination of features set forth herein can be excluded or omitted. To illustrate, if the specification states that a system or device comprises components A, B and C, it is specifically intended that any of A, B, or C, or any combination thereof, can be omitted and disclaimed singularly or in any combination, including but not necessarily with other components (e.g., D, E, etc.).

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Unless otherwise defined, all technical terms used herein have the same meaning as commonly understood by one of ordinary skill in the art to which this disclosure belongs.

What is disclosed herein are system and methods for suppressing the transition from laminar to turbulent fluid flow in conduits, defined broadly as any confined or semi-confined passageway for fluid transport, such as pipes of circular, or other, cross-sectional geometry, as well as channels of both the open and closed type. Examples include active control systems that adjust flow characteristics, which can include both open-loop and closed-loop systems, as well as active systems that are implemented without inputs (such as systems with pre-determined logic or modeling that replaces or supplements sensor inputs). Examples also include passive systems that are configured to selective or preferentially respond to certain fluid flow characteristics and, in response, modify the fluid flow to reduce or suppress turbulence transition (also referred to herein as turbulence development or turbulence growth). Such passive and active systems can be standalone systems, but further, examples include various combinations of active systems, passive systems, and active and passive systems together.

One of the aspects of the present disclosure are physical system and method implementations of a theoretical model developed by the inventors, and disclosed in more detailed herein, that accurately predicts the critical set of parameters that transition laminar flow in a pipe to a self-sustaining turbulent state. These parameters broadly include the fluid properties (e.g., density and viscosity), the pipe geometry (e.g., cross-sectional shape, surface roughness, and alignment), and the environment in which the pipe is disposed, specifically the spectrum of disturbances that may be imparted on the flow. The theoretical model presented herein reveals that there is a subset of perturbation modes with respect to the laminar flow, and one in particular that will be referred to as the transition mode, that are responsible for sustained turbulent flow when excited to sufficient amplitude. The spectrum of disturbances in the flow, both imposed by the external environment and excited by the flow itself, collectively excite the transition mode, considering both the frequency-amplitude spectrum of the disturbances and the frequency-amplitude response function for the transition mode.

Examples disclosed herein include systems and methods that are configured to suppress excitement of the transition mode, thereby enabling the sustaining of laminar flow at comparatively higher flow rates. Specifically, in some examples, the transition mode response function can peak, primarily, around one particular frequency that is a function of the flow parameters. This is referred to herein as the turbulence transition mode. Disturbances commensurate with this frequency lead to resonant excitation, where most others are off-resonance. Examples of the present disclosure can allow only (or at least, preferentially permit) off-resonant excitations of the fluid, which must then be orders-of-magnitude larger in amplitude to trigger sustained turbulence. Accordingly, examples of the present disclosure are able to effectively delay the turbulence transition to higher flow rates. Additional context, details, and examples are provided herein. Below is a non-limiting and non-exhaustive list of example turbulence suppression systems configured to reduce the turbulence transition mode of fluid flow in a conduit. Examples include conduit modifications, such as:
Active flow disturbance device, such as vibration-inducing devices, which can be mounted to the conduit interior or exterior surfaces, or within the thickness of the conduit wall. These active devices are configured to impart perturbations to the fluid in a manner that suppresses the transition mode. Active disturbance devices can also include fluidic or bubble injection, as well as magnetic manipulation of structures within the fluid flow.
Passive flow disturbance devices, such as textured surfaces, including specific liners, finishes, or patterns on interior conduit surfaces that directly interact with the fluid flow in the conduit and passively modify the fluid to suppress the transition mode. Examples include textures or patterns that generate specific flow structures that can transfer energy out of the turbulence transition mode. Examples of passive systems also include modified conduit cross-sections that create regions of the fluid flow with different turbulence transition modes. The turbulence transition mode is three-dimensional, and therefore may be suppressed by focusing on its streamwise wavelength, or cross-sectional structure. Examples include modifying a conduit's cross-section so that the conduit's geometry is incommensurate with development of the transition mode, thereby leading to suppression of turbulence. Modifications and design of conduit geometry can be done based on calculations of the predicted turbulence transition mode. The turbulence transition mode and it's response function are determined by the conduit geometry. Thus, for a given spectrum of disturbance imposed on the flow, examples include determining a conduit shape (e.g., cross-section shape and/or stream-wise path geometry) such that the amplitude response of the transition mode does not satisfy the criteria for transitioning to turbulence for the given spectrum of disturbance. Examples include using artificial intelligence and/or machine learning (with or without more conventional computational optimization methods) to design new conduit geometry and/or iterate conduit geometries toward a desired turbulence transition, flow rate, or other flow property.
Reactive flow absorption devices, such a deformable liners or flexible conduit walls that are acted upon by the flow and are configured to absorb energy the fluid flow, preferentially from the turbulence transition mode.

Example methods of implementation (and devices associated with the same) include manufacture of new pipes integrated with turbulence suppression technology, utilizing the embodiments disclosed herein, as well as on-construction-site pipe modifications/retrofits for turbulence suppression utilizing the embodiments disclosed herein. The distinction here is that more technological options exist for implementing turbulence suppression for a partially-assembled pipe before construction is complete. Implementations can include the modification and use of devices traditionally sent through pipelines regularly for cleaning and inspection, such as a Pipeline Inspection Gauge (PIG) or Pipeline Inspection Tools (PIT), that are configured to travel through existing pipelines and retrofit them from the interior for turbulence suppression. Examples of the present disclosure include such specialized devices. Notably, the turbulence suppression methods here may inversely be used to trigger turbulence in pipe flow. Therefore, examples of the present disclosure can be considered turbulence control systems, generally.

Examples of the model disclosed herein correctly predict the turbulence transition mode in pipes measured in a wide variety of seminal experimental studies. A key insight is that a particular flow disturbance of wavelength 2 (which is approximately two pipe diameters) is initially responsible for the transition of a pipe fluid flow from laminar to turbulent. Examples also include calculating the turbulent flow disturbance response (e.g., turbulence transition mode) for fluid flow in conduits, generally, which, while not strictly measured in diameters, and nevertheless a function of a characteristic length or lengths with respect to the geometry of the conduit. Any arbitrary disturbance to the pipe flow (e.g., an obstacle, external vibrations, and/or pipe bend) can be analyzed in terms of constitutive wavelengths and corresponding amplitudes of the disturbance, and specifically the degree to which each contributes to exciting λ₂, where a sufficient collective excitation of λ₀ triggers turbulence. Disturbance wavelengths similar to λ₀ can lead to resonant excitation such that exceedingly small amplitudes may cause the transition, while dissimilar wavelengths are off-resonance and require amplitudes orders-of-magnitude larger to cause the transition. Consequently, the transition from laminar to turbulent flow in a conduit can be effectively delayed by suppressing disturbances that are on-resonance with λ₀, rendering the flow laminar and stable at larger flow rates. Accordingly, examples of the present disclosure include systems and methods for active and/or passive controlling of the transition mode in a conduit flow to delay or prevent the transition of a conduit fluid flow from laminar to turbulent (e.g., increasing the flow rate required for the transition to develop) and this control can include, for example, selective absorption or cancellation of the transition mode in the fluid of a conduit flow.

Examples of disturbance suppression can be implemented in numerous straightforward ways utilizing off-the-shelf engineering hardware and software, and these collectively comprise a suite of technology options, as shown in more detail herein. Examples include retrofitting an external conduit wall with gentle vibration-inducing motors at specific locations and set to specific frequencies, incommensurate with λ₀, patterning the interior conduit wall with specific textures that have a periodicity incommensurate with λ₀, adding vibration-dampening materials tuned specifically with respect to λ₀. Pressure and vibration sensors may also be implemented for monitoring or active control. These systems and methods can be applied to existing pipe infrastructures, as well as to new pipe infrastructures at the point of construction with minimal logistical changes.

This disclosure includes an overview of the new fluid mechanical model of turbulence, including a brief discussion of example implementations, a more comprehensive description of the underlying mathematical model, and a number of non-limiting example systems and methods implementing aspects of the turbulence transition mode suppression based on the model.

The term turbulence transition mode and calculated turbulence transition mode can refer to a single number, but also encompasses permutations of that number, for instance because it is run through one or more optimizations methods, modules, etc. In addition, some aspects of the turbulence mode disclosed herein are presented for straight circular pipe flow, however one skilled in the art will appreciate that other conduit geometries are possible and that the mathematical framework presented herein is equally applicable to channel and conduit flows, generally, with the appropriate coordinates and constraints that would be known in the art. Nothing in the present disclosure is intending to be limited in any way to the particular circular pipe geometry used as the example for the derivations provided. One skilled in the art will immediately appreciate that any and all channel and conduit geometries can be used to develop a specific turbulence model and subsequent turbulence transition mode for flow conditions in the geometry, including the use of computational assistance, such as numeral modeling, in order to apply aspects of the present disclose to complex geometries.

Additionally, examples of the present disclosure include using experimentation to improve and/or adjust the turbulence transition mode for a physical system. Because aspects of the turbulence model disclosed herein approximate certain flow features (e.g., treating the flow as a continuum), real physical systems may act slightly different. For example, while the model of a pipe used herein is assumed to be perfectly symmetric and of constant diameter, such perfect constructions are almost impossible to achieve in practice and, similarly, fluid properties can vary slightly (e.g., changes in temperature or impurities). Accordingly, subtle deviations from the assumptions used in the turbulence model could result in small differences between a calculated turbulence transition mode and the response of a physical system. Examples of the present disclosure include using experimentation to assess the ability of a calculated turbulence transition mode to reduce turbulence and, if necessary, modify or recalculate the calculated turbulence transition mode based on observations from the experimentation. This can be implemented using a controller in a system whereby a calculated turbulence transition mode is used to alter a system and measurement of the system is used to generate feedback to the controller to adjust the calculated turbulence transition mode used to alter the system. Examples also include, given calculated turbulence transition mode of a physical system, testing the physical system using the calculated turbulence transition mode to see if the measured system response matches predictions and, if not, adjusting the implementation of the calculated turbulence transition mode based on the measurements. This can include, for example, re-calculating the turbulence transition mode using new parameters/constraints that were determined experimentally to be more correct representations of the physical system. For example, while a pipe can be assumed in a first calculated turbulence transition mode to be perfectly straight, subsequently testing can determine that the measured turbulence transition of the flow behaves more similarly to a pipe with a slight curve, asymmetry, or other deviation. Thereafter, a new turbulence model can be generated to calculate a new turbulence transition mode and/or a function can be determined to map the calculated turbulence transition mode to the measurements of the physical system being approximated by the turbulence model, thereby enabling control of the physical system using the calculated turbulence transition mode and experimentally determined mapping function.

### New Fluid Mechanics of Turbulence

From a theoretical point of view, the open challenge has been to develop a complete general mathematical framework that accurately captures chaotic fluctuating patterns observed in turbulent flows. The basic mathematical statement of the problem is to find a general solution to the Navier-Stokes equations—the governing differential equations of motion—for an incompressible fluid, given by Equations 1A and 1B:

$${\partial }_{t} v = - \frac{1}{ρ} ∇ 𝒫 + v {∇}^{2} v - ( v \cdot ∇ ) v + f \qquad ( Equation 1 A )$$

$$∇ \cdot v = 0 \qquad ( Equation 1 B )$$

Equations 1A and 1B adequately describe turbulent fluid flow. These equations characterize a fluid density p and kinematic viscosity v, subject to external body forces f, in terms of its velocity v and pressure P fields.

Understanding the precise role played by the following nonlinear convective term: (v·∇)v has been a major theoretical difficulty. If turbulent flow is considered to include velocity fluctuations across a wide range of length scales, this term, being an operator product of v with itself, constitutes an interaction between these disparate length scales. A concept for these turbulent interactions should be formalized to carry out a mathematical treatment of the problem. The established approach, originated by Reynolds, is to decompose the complete flow field v into a time-averaged mean flow v̅ plus a component fluctuating about the mean dv (e.g., v=v̅+δv where δv=0. Substituting this decomposition into Equations 1A and 1B yields the Reynolds-averaged Navier-Stokes equations of Equations 2A and 2B:

$${\partial }_{t} \overline{v} = - \frac{1}{ρ} ∇ \overline{𝒫} + v {∇}^{2} \overline{v} - ( \overline{v} \cdot ∇ ) \overline{v} - \overline{( δ v \cdot ∇ ) δ v} + \overline{f} \qquad ( Equation 2 A )$$

$$∇ \cdot \overline{v} = ∇ \cdot δ v = 0 \qquad ( Equation 2 B )$$

In Equations 2A and 2B, the bars over terms denote a time average. An important subtlety in this decomposition is that the time average leaves v̅ and δv coupled to one another in a peculiar manner due, at least in part, to the time average being performed over the whole flow. This leads to a closure problem, whereby a relationship between v̅ and δv must be prescribed to form a set of solvable equations. The closure problem simply reflects the fact that the relationship between v̅ and δv is not bijective, as the same v̅ can correspond to many different spectra of fluctuations for δv. This constitutes the primary theoretical challenge that leading to this disclosure has yet to be solved, and in turn has limited practical progress towards engineering solutions to control the development of turbulence in conduit flows.

Aspects of the present disclosure include a new general mathematical framework for turbulent fluids derived from first principles. In this context, the present disclosure includes a model framework that is the first general closed-form representation for the Navier-Stokes equations, and constitutes a significant theoretical advance in its own right regarding the general hydrodynamic description of physical systems. One insight is centered around formalizing the picture of turbulent fluctuations in a manner differing from that of Reynolds (i.e., Equations 2A and 2B), by decomposing the complete flow field v into a regular base flow U that exists in the absence of turbulent motions, plus a component u corresponding to all turbulent motions (e.g., v=U+u). One important distinction is that the base flow U does not involve a time average, and corresponds to the laminar flow through the domain of the fluid, independent of any additional fluid motions that may arise. This enables a different modeling path that sidesteps the closure problem, where the turbulent motions are formulated explicitly with respect to U and represented through the velocity field u in closed form. In essence, the complete flow field was viewed through a fluid domain v as always comprised of at least a laminar part U, which is unambiguous and serves as part of the domain definition for any turbulent motions u superposed onto it. From here, a spectral decomposition was performed for the turbulent portion of the flow, and this represents the full dynamical picture in terms of turbulent kinetic energy density eigenstates. This new mathematical framework allows several important theoretical challenges to be redressed for the first time, two of which are highlighted below:

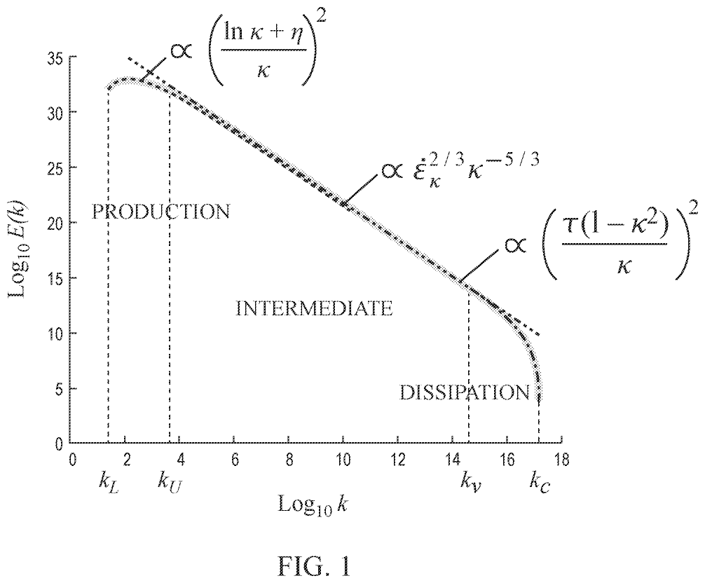

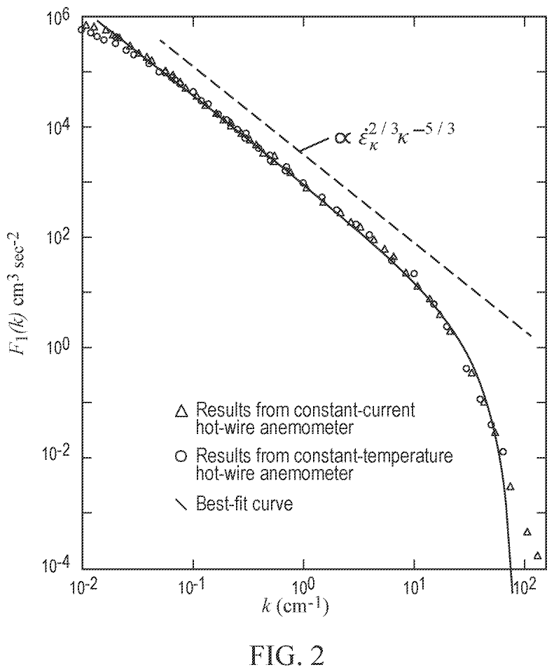

1. A derivation of the complete turbulent energy spectrum from first principles, an example of which is presented in FIG. 1, which shows the turbulent kinetic energy E (k) as a function of the wavenumber k of turbulent fluctuation in the turbulent fluid, according to aspects of the presently disclosed theoretical model. The spectrum of FIG. 1 depicts the three typical regimes of the energy spectrum: the production range, which corresponds to fluctuations on the size of the fluid domain (and depend on the domain's geometry); the intermediate range (often called the inertial subrange), which corresponds to an inviscid cascade of energy from smaller to larger wavenumbers; and the dissipation range, where viscous dissipation is significant. Detailed experimental measurements of turbulent energy spectra have been reported throughout the past 60 years; however, no portion of the energy spectrum has been rigorously derived mathematically. Comparisons between example of the presently disclosed model and published experimental data yields excellent agreement and serves to validate the present turbulence model. FIG. 2 shows historical data measuring the turbulent energy spectrum of highly turbulent air flowing through a circular pipe, overlaid with a curve corresponding to aspects of the presently disclosed theoretical model.

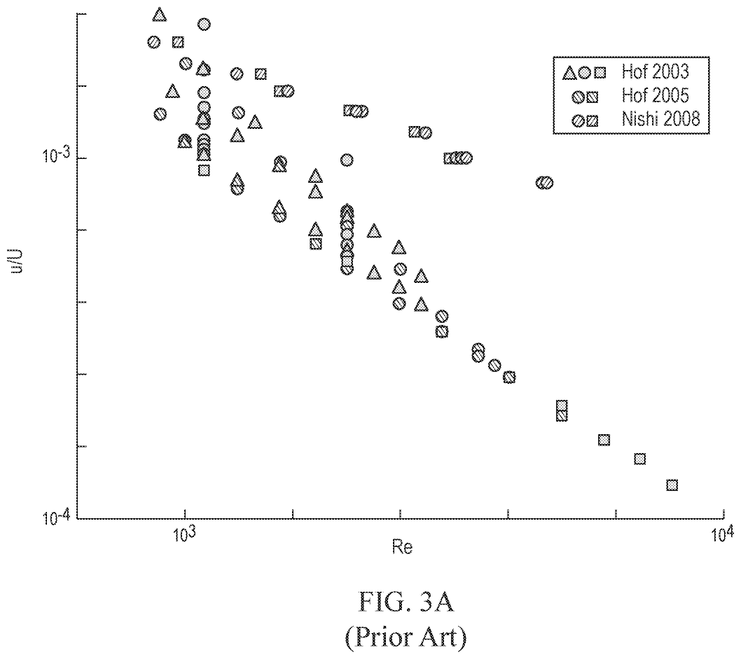

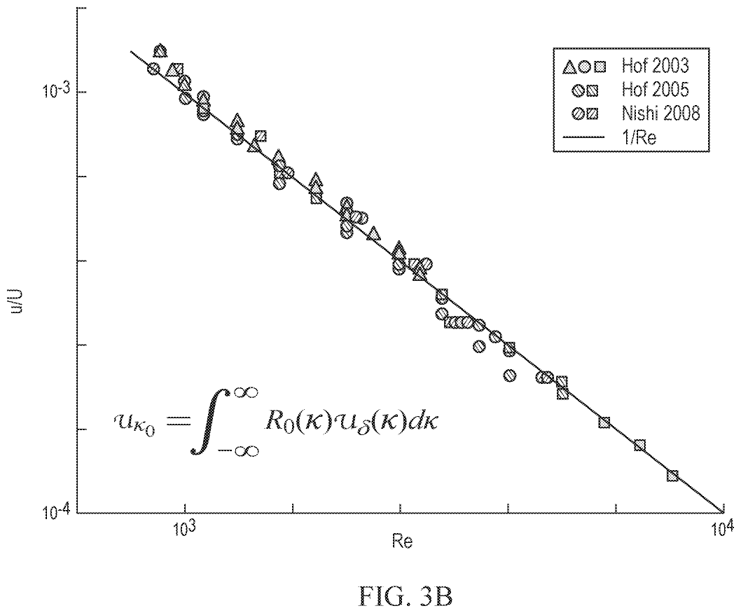

2. Predicting the laminar-turbulent transition for pipe flow. Predicting the transition from laminar to turbulent flow in a cylindrical pipe is considered a classic unsolved theoretical challenge, and was first posed as a scientific challenge by Reynolds in the 1880s. Using the theoretical turbulence model described herein, critical flow parameters can be derived that define the turbulence transition in a cylindrical pipe, and successfully collapsed the seminal experimental data published over the past 30 years onto a single curve, affirming additionally the existence of a universal power law. Representative examples of prior experimental data are presented in FIG. 3A (described in more detail below), and a collapse of this data according about examples of the present theoretical turbulence model is illustrated in FIG. 3B. Certain aspects of the present disclosure leverage insights pertaining to these result, which are, in some examples, translated into specific systems and methods for suppressing or reducing the development on turbulent flow in pipes and conduits.

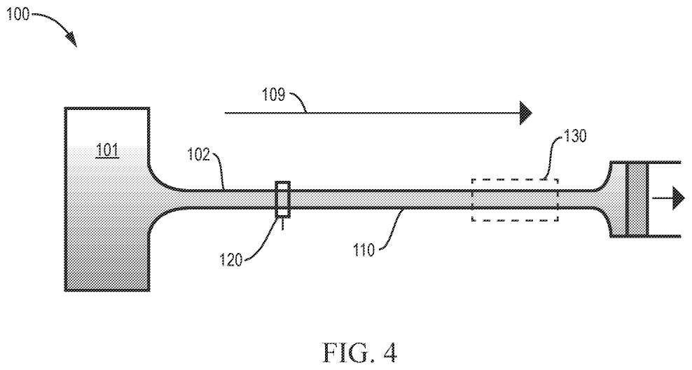

Before detailing specific insights, implications, and example implementations arising from the presently disclose turbulence model, a description is provided of the prior experimental work in the academic literature measuring the transition from laminar to turbulent flow in a straight circular pipe of diameter D=2R, where R is the pipe's radius. FIG. 4 illustrates a standard experimental procedure 100 to introduce a precision disturbance into a fully developed and time-independent laminar flow through a pipe. The example system 100 includes a fluid source 101 and a conduit 110 through which a laminar flow 102 of the fluid is created (with a direction of the fluid flow as indicated by arrow 109). The system 100 includes an inlet 120 to the conduit 110, which is where a disturbance in the laminar flow 102 can be generated and a region 130 downstream from the inlet 120 where flow conditions can be observed. The flow can be observed many pipe diameters downstream, where the first instance of a discrete persistent turbulent “puff” marks the transition boundary between disturbances that relaminarize and those that persist. In practice, and for pipe flow, the turbulent puff is always observed experimentally to be approximately in the range of about 5 to about 10 pipe diameters long, surrounded by laminar flow upstream and downstream, and travelling at approximately the flow's mean speed U. The persistence of a turbulent puff simply indicates a steady state balance between the kinetic energy entering at the puff's upstream boundary and the turbulent viscous energy dissipation within the volume of the puff. In addition to the fluid's density ρ and viscosity μ (or equivalently v=μ/φ, the flow in the pipe is characterized by its pressure gradient

$$\frac{\partial P}{\partial z}$$

and mean speed Ū. These quantities, in addition to the details of the particular method of flow disturbance, define the transition.

The data of FIGS. 3A and 3B include the experimental measurements from three different papers (discussed in more detail below), where different data point shape indicates the corresponding paper, and the different hatching infill indicates each separate experimental run. A brief description of the method of flow disturbance for each paper of FIGS. 3A and 3B is listed below.

The solid data points in FIGS. 3A and 3B show experimental results from a 2003 paper by Hof et al. (Scaling of the turbulence transition threshold in a pipe, Physical Review Letters, 91:244506, 2003). In these experiments, a square-pulsed fluid injection was introduced through six small holes in an interior pipe wall. The disturbance metrics were the duration of time t of the pulse, reported as the streamwise length of the disturbed flow L=Ūt, and the flux rate into the pipe over the duration of the pulse.

The first hatched (down, to the right) data points in FIGS. 3A and 3B show experimental results from a 2005 paper by Hof (Transition to turbulence in pipe flow. Fluid Mechanics and its Applications, 77, 2005). In these experiments, flow was disturbed a manner analogous to the 2003 Hof results of FIGS. 3A and 3B, however the fluid pulse was delivered through one relatively larger hole in the interior pipe wall, instead of six.

The second hatched (down, to the left) data points in FIGS. 3A and 3B experimental results from a 2008 paper by Nishi et al. (Laminar-to-turbulent transition of pipe flows through puffs and slugs. Journal of Fluid Mechanics, 614). In these experiments, a ring obstacle was placed inside the pipe to disturb the flow. The ring featured an outer radius identical to the inner radius of the pipe, and an inner radius of smaller diameter. The metric for the amplitude disturbance was the radial thickness of the ring (e.g., the difference between the outer and inner radii of the ring). The pipe flow rate was incrementally increased until the turbulence transition was reached.

An important observation from the results of these earlier works on turbulence transition is the disparate trends for the turbulence transition indicated by each experimental run. This is made explicit in FIG. 3A, where the horizontal axis is the dimensionless flow rate through the pipe Re=ŪR/v (i.e., the Reynolds number for the flow), and the vertical axis represents the velocity of the flow disturbance u imposed on the laminar flow, normalized by the mean flow rate U. For Hof (2003) and Hof (2005), u is simply the average velocity of the flow exiting the holes in the pipe's interior wall. For Nishi (2008), the average velocity difference between the upstream laminar flow and the turbulent flow through the inner radius of the ring is used, which on average is uniform across the inner hole of the ring.

According to the theoretical model presented herein, there exists particular wavelengths λᵢ of fluctuating disturbances within the flow that are primarily responsible for the laminar-turbulent transition. These wavelengths can be identified in order of decreasing size (i.e., {λ₀, λ₁, λ₂, . . . }), which represents an ordered list of wavelengths descending in size. Equivalently, these fluctuations can be considered in terms of their wave numbers kᵢ=2π/λᵢ, which represent the spatial frequency of the fluctuation; this in turn yields a corresponding ordered list of increasing wave numbers {k₀, k₁, k₂, . . . }. Any arbitrary disturbance to the fluid flow within the pipe (e.g., an obstacle, external vibrations, pipe bend, surface roughness, etc.) may be analyzed in terms of its constitutive wavelengths and corresponding amplitudes, and specifically the degree to which each contributes to exciting these particular wave numbers kᵢ. The velocity amplitude of the disturbance corresponding to kᵢ is given by uₖ, and sustained turbulence is triggered when the amplitude uₖi is sufficiently large

The significance of ordering the particular set of wave numbers responsible for the laminar-turbulent transition as {k₀, k₁, k₂, . . . } is the following. These particular spatial fluctuations become important with respect to the turbulent transition in a sequential manner as the non-dimensional flowrate Re increases. For example, at small Re, only k₀ is of concern for determining the transition criteria. As Re increases, the set {k₀, k₁} can be found to become important. Further increasing Re can then require consideration of the set {k₀, k₁, k₂}, and so on.

The physical picture for the laminar-turbulent transition just described may be summarized in terms of a response function Rᵢ(k) for each kᵢ, which is multiplied by the spectrum of velocity fluctuations u_{δ}(k) present in the fluid and then this product is integrated over all k. Non-dimensionalizing the wave numbers by the pipe radius, κ=Rk, the integration formula reads as follows in Equation 3:

$${u}_{{k}_{i}} = {\int }_{- ∞}^{∞} {R}_{i} ( k ) {u}_{δ} ( k ) dk \qquad ( Equation 3 )$$

In Equation 3, uₖᵢ is the amplitude of the fluctuation with wave number kᵢ, which accounts for the additional amplitude excitement due to nonlinear exchanges. Generally, the specific formula for the response functions Rᵢ(K) can depend on the geometry of the conduit. For all data points in FIG. 3A the disturbance amplitude imposed in the experiments is only sufficient to meet the transition criteria for k₀. For a circular pipe, and the new turbulence transition model shows that R₀(K) works out to be Equation 4:

$${R}_{0} ( k ) = \frac{1}{π} \frac{1}{{( k = {k}_{0} )}^{2} + 1} \qquad ( Equation 4 )$$

where, in Equation 4,

$${k}_{0} = \frac{π}{2} ,$$

which corresponds to a wave length of λ₀=4R=2D (i.e., two pipe diameters in length). Accordingly, Equation 5 is established:

$${u}_{{k}_{i}} = {\int }_{- ∞}^{∞} {R}_{0} ( k ) {u}_{δ} ( k ) dk = \frac{1}{π} {\int }_{- ∞}^{∞} \frac{{u}_{δ} ( k ) dk}{{( k = {k}_{0} )}^{2} + 1} \qquad ( Equation 5 )$$

For Equation 5, the disturbance spectrum u_{δ}(κ) can be determined through simple estimates based on the details of each experimental setup and method of disturbance applied to the laminar flow. Based on Equation 5, the condition for a sustained turbulent state to appear in the flow becomes Equation 6:

$${u}_{δ} ( k ) \geq u \qquad ( Equation 6 )$$

In Equation 6, u is a constant with units of velocity. Re-scaling of the vertical axis in FIG. 3A in accordance with Equation 5 leads to a collapse of all data points onto a single curve ∝Re⁻¹, as shown in FIG. 3B. The resultant data collapse in FIG. 3B not only validates the presently disclosed theory of turbulence, but also to explain the disparate trends in the experimental measurements as originally reported in the data of FIG. 3A. Said simply, if the spectrum of velocity fluctuations in the fluid u_{δ}(κ) contains wave numbers similar to κ₀, this leads to resonant excitation of u_{κ}0, such that exceedingly small amplitudes of flow disturbance may cause the transition. Conversely, if the spectrum of velocity fluctuations in the fluid u_{δ}(κ) only contains wave numbers dissimilar to κ₀, the off-resonant and require amplitudes orders-of-magnitude larger to cause the transition. Accordingly, one insight underlying aspects of the present disclosure is that the turbulence transition can be effectively delayed by suppressing disturbances that are on-resonance with κ₀, rendering the flow laminar and stable at larger flow rates. More generally, the suppression of all {κᵢ} that are important, based on the flow rate through the conduit, will render the flow laminar.

### Example Turbulence Control Systems

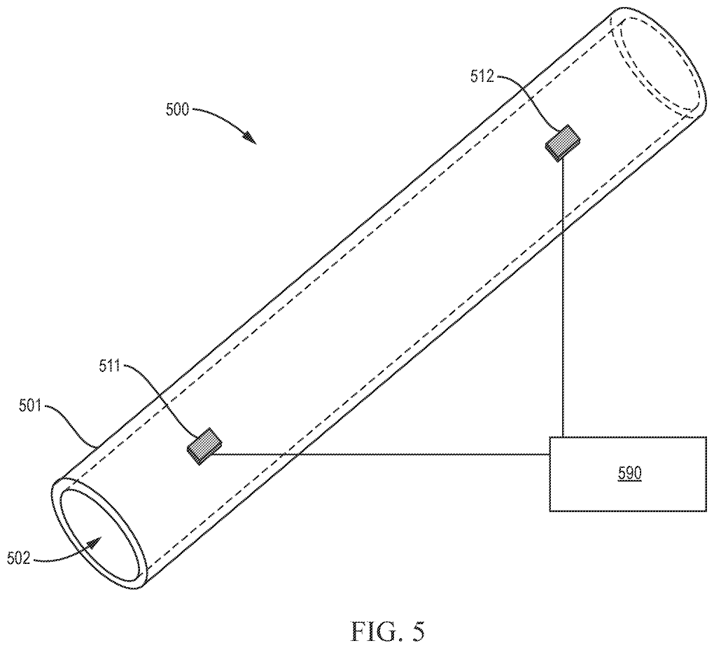

Examples of the present disclose also include systems and methods for controlling turbulence in conduit flow based on a turbulence transition mode calculated using the turbulence transition model disclosed herein. Examples can include calculating one or more turbulence transition modes for a given conduit or conduit flow and modifying the fluid flow in the conduit to suppress the turbulence transition mode. Examples include configuring a device and/or modifying the conduit to generate disturbances in the fluid flow that suppress the turbulence transition mode, and other examples include devices and methods that selectively/preferentially absorb energy from the turbulence transition mode in the fluid flow, thereby suppressing the turbulence transition mode. Examples also include systems for measuring, sensing, or otherwise observing fluid flow in a conduit (including, optionally, measuring any other parameters related to calculating the turbulence transition mode, including geometric parameters of the conduit) and calculating the turbulence transition mode, which may be done offline, remotely, and/or in real-time to control the generation of disturbances in the fluid flow to suppress the turbulence transition mode. These and other examples can be can be implemented in numerous ways utilizing off-the-shelf engineering hardware and software, and these collectively comprise a suite of technology options, certain examples of which are illustrated in FIGS. 5-11. Generally, examples include using the presently disclosed turbulence model to reduce turbulence in conduit flow by calculating the turbulence transition mode for a given conduit flow, which can be for a specific flow condition, or a plurality of possible flow conditions through the conduit, and causing, in the fluid flow in the conduit, a suppression of the calculated turbulence transition mode.

According to the presently disclosed turbulence model, suppression of the calculated turbulence transition mode in a conduit fluid flow will delay or prevent the transition of a laminar fluid flow in the conduit to a turbulent state. This can, for example, allow laminar higher fluid flow rates to be achieved in the conduit so long as suppression of the turbulence transition mode is sustained. Moreover, for dynamic flow conditions, examples include active open loop and closed-loop control, which can, for example, include sensors or other measurement techniques for generating information regarding the conditions of the fluid flow in a conduit and, subsequently (including in real-time), using a control system to generate/adjust a flow disturbance command that is provided to an active flow disturbance device (in communication with the fluid) that maintains suppression of the turbulence transition mode. Examples of active control can be used where flow conditions change due to, for example, the initiation of a fluid flow or some change in the fluid flow, such as due to a temperature change, flow rate change, pressure change, or any other fluid parameters that can affect the turbulence transition mode. Examples include real-time calculation of a turbulence transition mode, which can be used, for example, as conduit parameters and/or flow parameters change. Conduit parameters can change, for example, due to a change in temperature of the fluid causing thermal contraction/expansion of the conduit structure, which can modify the conduit geometry, and thereby the turbulence transition mode.

Examples also include using feedback directly from the flow disturbance devices as well, such as a backpressure (for fluidic injection devices), or impedance (for electrical devices, such as vibration-inducing devices). In these examples, the ability to drive the disturbance device(s) can be use by a control system to determine the conditions of the fluid being disturbed, and thus determine if the turbulence transition mode is being suppressed as desired. Moreover, one of ordinary skill in the art will appreciate that there exist a large number of technologies for sensing conduit flow conditions, including parameters related specifically to laminar and turbulent flow, and any of these existing techniques can be combined with a control system that includes one or more active flow control devices in the conduit (or otherwise mechanically, thermally, acoustically, magnetically, electromagnetically, and/or fluidicly coupled with the fluid flow in the conduit) that can be used to suppress the turbulence transition mode of a fluid flow in the conduit. Examples also include using input from fluid conditions upstream and/or downstream of the conduit, which can be used to extrapolate flow parameters in the conduit. Examples also include moveable flow control structures, such as articulating surfaces or vanes that can be disposed within the conduit or deployable from an outside-the-conduit (and/or outside the fluid flow) position to an inserted or deployed position within the flow. In the fluid flow, geometric and positon parameters (e.g., extension, intrusion, angle of attack, etc.) of the structure can be adjusted by a control system to modify flow parameters of the fluid flow to suppress the turbulence control mode. Additional non-limiting examples include control structures that are moveable portions of the conduit wall.

Examples of the present disclosure also include passive and reactive turbulence control systems that are configured to absorb and/or suppress a calculated turbulence control mode of fluid flow in a conduit without with or without active control. Here, the term reactive refers to structures that move or otherwise respond to fluid flow in a particular way that absorbs energy from the fluid to suppresses the turbulence transition mode in the fluid, while passive refers to static structures, coating, and textures that are not configured to utilize kinetic energy from the fluid flow to modify the fluid flow to suppress the turbulence transition mode in the fluid. Examples include liners, such as flexible or deformable liners, disposed on at least a portion of an inner wall of a conduit and that are configured to absorb energy from the turbulence transition mode of the fluid flow. Example lines can have material properties that preferentially deform at or about the turbulence transition mode such that energy from the fluid at or about the turbulence transition mode is transferred into deformation of the liner, thereby suppressing the turbulence transition mode in the fluid. Examples include patterns, textures, and/or coating applied to the inner wall of a conduit that modify fluid properties as the flow flows across the patterns, textures, and/or coating such that the modified fluid properties cause suppression of the turbulence transition mode in the fluid. Passive control examples include moveable structures/surfaces that are not actively controlled, but otherwise are moving or able to move in the fluid flow in response to movement of the fluid such that the structures/surfaces absorb energy from the turbulence transition mode in the fluid.

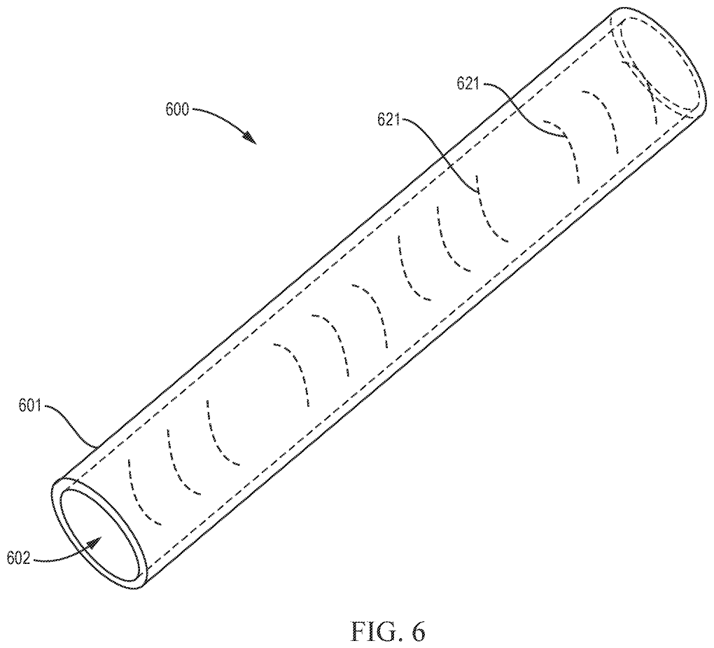

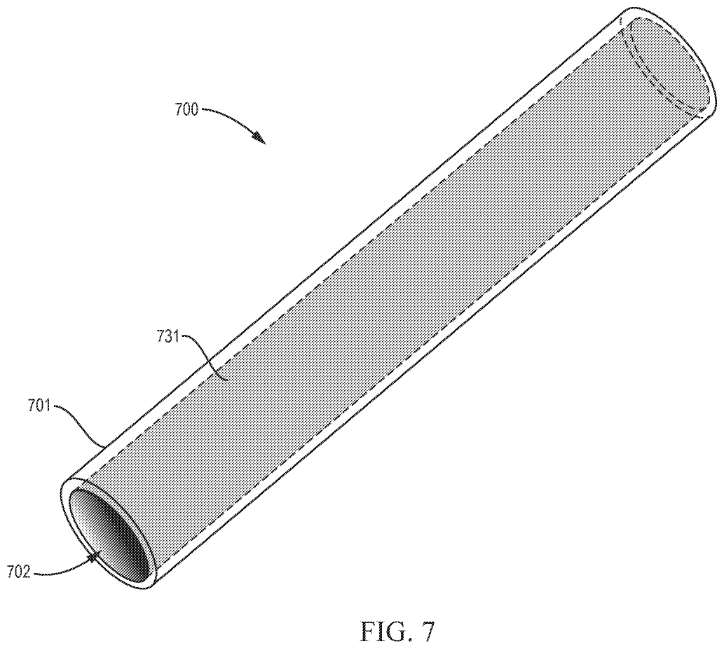

FIGS. 5-11 show exemplary embodiments for turbulence control. FIG. 5 illustrates an example turbulence control system 500 that include a conduit 501 with vibration-inducing devices 511 placed at strategic locations on the exterior of the conduit 501, which can, optionally, includes sensors 512 for closed-loop control. FIG. 6 illustrates an example turbulence control system 600 that includes textures 621 patterned on an interior surface of a conduit 601. FIG. 7 illustrates an example turbulence control system 700 that includes a conduit 701 with a specifically tuned vibration-dampening material 731 lining an interior of the conduit 701. For any of the examples presented herein, the inner wall of the conduit (e.g., a wall that comes into contact with fluid flowing through the conduit) may be coated to ensure chemical compatibility. Additionally or alternatively, vibration dampening materials may be introduced between the pipe and its external support structure.

Examples systems and implementations of the turbulence control enabled by aspects of the present disclosure include the retrofitting the external pipe wall with gentle vibration-inducing motors at specific locations, and/or set to specific frequencies, incommensurate with the relevant κᵢ (as, for example, the active turbulence control system of FIG. 5). Examples also include patterning the interior pipe wall with specific textures that have a periodicity incommensurate with the relevant κᵢ (using, for example, the passive turbulence control system of FIG. 6), and adding vibration dampening materials tuned specifically with respect to the relevant κᵢ (using, for example, the reactive turbulence control system of FIG. 7). Examples also include pressure and vibration sensors implemented for monitoring or active control. These methods can be applied to existing pipe and conduit infrastructures, as well as to new pipe and conduit infrastructures at the point of construction with minimal logistical changes.

An example system 500 that includes a conduit 501 (e.g., a pipe, as shown) and an active turbulence control system according to aspects of the present disclosure is shown in FIG. 5. The active turbulence control system includes a controller 519, a vibration-inducing device 511 disposed on an exterior portion of the conduit 501, as well as a sensor 512 configured to sense parameters indicative of the conditions of the fluid flow in the conduit 501. While FIG. 5 shows a single vibration-inducing device 511 and a single sensor 512, this is just one example and examples include a plurality of either (or both) devices and sensor that can work together or individually. The vibration-inducing devices 511 can be configured to create flow disturbances within a fluid flowing through the passageway 502 of the conduit. The flow disturbances generated by the vibration-inducing devices 511 can be specifically configured to suppress specific frequencies of energy in the fluid flow in the passageway 502 of the conduit 501, the suppressed frequencies being based on or about a calculated turbulence transition mode of the flow in the passageway 502. The turbulence transition mode can be calculated according to any aspects of the presently disclosed turbulence control model. The controller 519 can, in some instances, calculate or adjust the calculation of the turbulence transition mode based on information received from the vibration-inducing devices 511 and/or the sensors 512. The controller 519 can be external to the conduit and/or incorporated as part of one or more of the devices 511/sensors 512. In other words, the controller can be disposed virtually anywhere even though illustrated as being “outside” of the conduit. The sensors 512 can be disposed within the conduit 501, on or about an external portion of the conduit (as shown), or otherwise associated with the conduit 501 such that measurements or observations of information indicative of the fluid flow in the conduit can be received and provided to the controller 519 for use in, for example, adjusting the generated flow disturbances and/or adjusting the calculated turbulence transition mode. In operation, a fluid flowing through the passageway 502 of the conduit 501 can be acted upon by the vibration-inducing devices 511 and thereby is able to achieve, for example, a high flow rate without having the fluid flow transition to turbulence. The use of a controller 519 enables, for example, suppression of turbulence in a number of different flow conditions and even for different fluids and fluid properties.

Alternatively, the vibration-inducing devices 511 can act on the fluid flow to increase the energy of the fluid flow in the turbulence transition mode and reduce the fluid flow rate at which the fluid flow transitions to turbulent. The vibration-inducing devices 511 can be added to an existing conduit and/or integrated or associated with a new conduit during or after manufacture of the conduit. While the vibration-inducing devices 511 of FIG. 5 has been shown as being external to the passageway 502, examples include devices that have both external and internal components, such as a vibration-inducing devices with a motor external to the conduit and an emitter coupled with the external motor that extends into the passageway 502 through an opening in the conduit 501, among other configurations for vibration-inducing devices that a person skilled in the art, in view of the present disclosure, will be able to use in conjunction with conduits of the nature of the conduit 501 without departing from the spirit of the present disclosure.

An example system 600 that includes a conduit 601 (e.g., a pipe, as shown) and a passive turbulence control system according to aspects of the present disclosure is shown in FIG. 6. The passive turbulence control system includes a plurality of flow disturbance-inducing features 621 disposed on an interior wall of the conduit 601. The flow disturbance-inducing features 621 can be configured to create flow disturbances within a fluid flowing through the passageway 602 of the conduit 601. The flow disturbances generated by the flow disturbance-inducing features 621 can be specifically configured to suppress specific frequencies of energy in a fluid flow in the passageway 602 of the conduit 601, the suppressed frequencies being on or about a calculated turbulence transition mode of a fluid flow in the passageway 602. The turbulence transition mode can be calculated according to any aspects of the presently disclosed turbulence control model. The flow disturbance-inducing features 621 can include, for example, patterns, textures, raised or subtracted regions and surfaces, as well as a coating(s) and/or finish(es) on the inner wall of the conduit 601.

An example system 700 that includes a conduit 701 (e.g., a pipe, as shown) and a reactive turbulence control system according to aspects of the present disclosure is shown in FIG. 7. The reactive turbulence control system includes a resilient deformable liner 731 disposed on, or forming, an interior wall of the conduit 701. The resilient deformable liner 731 is configured to create flow disturbances within a fluid flowing through the passageway 702 of the conduit 701 by absorbing energy from the fluid. The flow disturbances generated by the resilient deformable liner 731 can be specifically configured to suppress specific frequencies of energy in a fluid flow in the passageway 702 of the conduit 701, the suppressed frequencies being on or about a calculated turbulence transition mode of a fluid flow in the passageway 702. The turbulence transition mode can be calculated according to any aspects of the presently disclosed turbulence control model. The resilient deformable liner 731 can be configured from one or more materials, including internal and external structures, voids, and/or other non-uniformities to create a specific response by the resilient deformable liner 731 to certain flow conditions, such as oscillations in the fluid on or about the turbulence transition mode. In operation, the resilient deformable liner 731 can be preferentially responsive to movements in the fluid on or about the turbulence transition mode such that those movements cause a peak in the movements of the resilient deformable liner 731, thereby transferring energy from the fluid to or about the turbulence transition mode. Example resilient deformable liners can also include features of the passive turbulence control systems disclosed herein, such as patterns or surface textures or coatings. Additionally, the resilient deformable liner can include an active control system that can, for example, modify the resiliency or other property(ies) of the liner, for example, in changing a fluid pressure of a cavity within the resilient deformable liner and/or moving an additional fluid into or out of the resilient deformable liner and/or actuating mechanical systems therein, such as shock absorbers, dampeners, and/or smart materials with adjustable mechanical response properties.

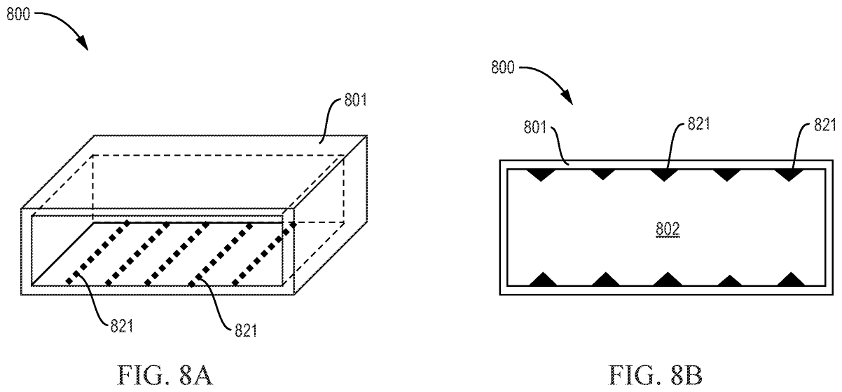

Another example system 800 that includes a conduit 801 (e.g., square channel, as shown) and a passive turbulence control system according to aspects of the present disclosure is shown in FIGS. 8A and 8B. The passive turbulence control system includes a plurality of flow disturbance-inducing features 821 disposed on an interior wall of the conduit 801. The flow disturbance-inducing features 821 are configured to create flow disturbances within a fluid flowing through the passageway 802 of the conduit 801. The flow disturbances generated by the flow disturbance-inducing features 821 can be specifically configured to suppress specific frequencies of energy in a fluid flow in the passageway 802 of the conduit 801, the suppressed frequencies being on or about a calculated turbulence transition mode of a fluid flow in the passageway 802. The turbulence transition mode can be calculated according to any aspects of the presently disclosed turbulence control model. The low disturbance-inducing features 821 of FIGS. 8A and 8B are protrusions that extend inwardly into the passageway 802 and can, for example, change the turbulence transition mode across the width of the passageway 802 such that, for example, more than one turbulence transition mode is present. This can induce transfer of energy between adjacent regions of the passageway 802 and transfer energy away from a calculated dominate turbulence transition mode of the passageway 802, thereby increasing the flow rate through the conduit 801 before turbulence transition occurs. While FIGS. 8A and 8B show the disturbance-inducing features 821 as alternating about a lateral direction, streamwise and any other directions are conceived and can depend on, for example, the flow disturbances necessary to suppress a dominate turbulence transition mode of the conduit 801.

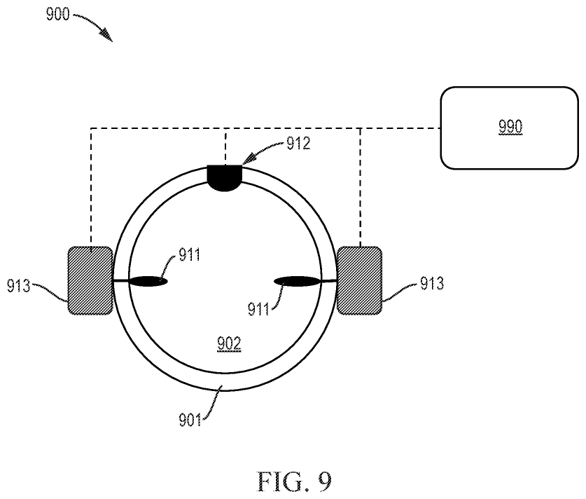

Another example system 900 that includes a conduit 901 (e.g., a pipe, as shown) and an active turbulence control system according to aspects of the present disclosure is shown in FIG. 9. The active turbulence control system includes a controller 990, a plurality of moveable flow-control devices 911 disposed on, and extending from, an interior portion of the conduit 901, as well as a plurality of sensors 912 configured to sense parameters indicative of the conditions of the fluid flow in the conduit 901. The moveable flow-control devices can be configured to create flow disturbances within a fluid flowing through the passageway 902 of the conduit 901, which can be done, for example, by moving or positioning the moveable flow-control devices 911, which can include, for example, vanes or other flow control surfaces and structures known in the art. The system includes motors 913 coupled with the moveable flow-control devices 911 to control their movement and/or position. The flow disturbances generated by the moveable flow-control devices 911 can be specifically configured to suppress specific frequencies of energy in the fluid flow in the passageway 902 of the conduit 901, the suppressed frequencies being on or about a calculated turbulence transition mode of the flow in the passageway 902. The turbulence transition mode can be calculated according to any aspects of the presently disclosed turbulence control model. The controller 990 can, in some instances, calculate or adjust the calculation of the turbulence transition mode based on information received from the motors 913 and/or the sensors 940. The sensors 940 can be disposed within the conduit 902 (as shown), on or about an external portion of the conduit, and/or otherwise associated with the conduit 901 such that measurements or observations of information indicative of the fluid flow in the conduit can be received and provided to the controller 990 for use in, for example, adjusting the generated flow disturbances and/or adjusting the calculated turbulence transition mode. In operation, a fluid flowing through the passageway 902 of the conduit 901 can be acted upon by the moveable flow-control devices 911 and thereby can be able to achieve, for example, a high flow rate without having the fluid flow transition to turbulence.

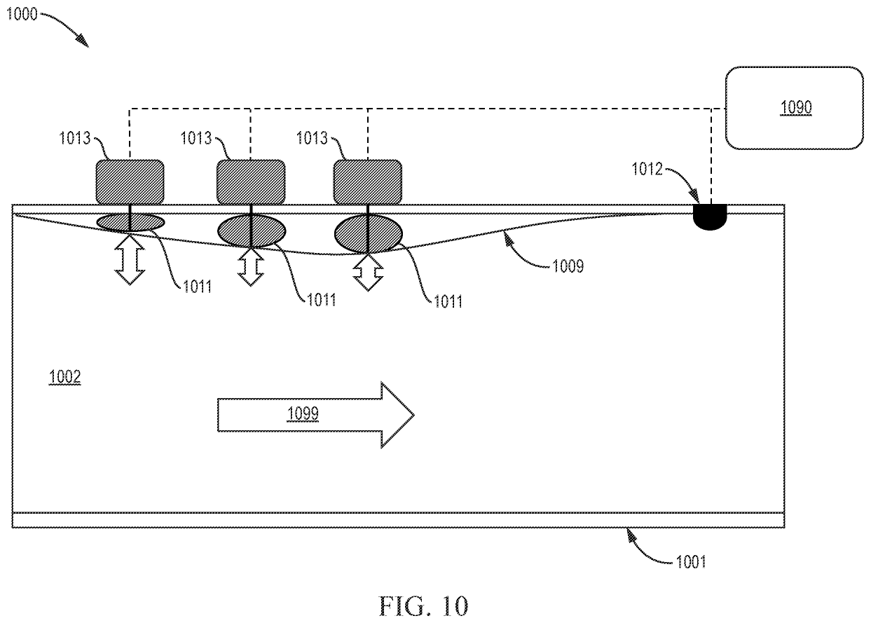

Yet another example system 1000 that includes a conduit 1001 and an active turbulence control system according to aspects of the present disclosure is shown in FIG. 10. The active turbulence control system includes a controller 1090, a plurality of flow-control devices 1011 configured to modulate the position and shape of an interior portion 1009 of the conduit 1001, as well as a plurality of sensors 1012 configured to sense parameters indicative of the conditions of the fluid flow in the conduit 1001. The flow-control devices 1011 can be configured to create flow disturbances within a fluid flowing (as indicated by arrow 1099) through the passageway 1002 of the conduit 1001 by controlling the position and shape of the interior portion 1009. The system 1000 includes motors 1013 coupled with each flow-control devices 1011 to control their movement and/or position and, thereby, the position and shape of an interior portion 1009. The flow disturbances generated by the moveable interior portion 1009 can be specifically configured to suppress specific frequencies of energy in the fluid flow in the passageway 1002 of the conduit 1001, the suppressed frequencies being on or about a calculated turbulence transition mode of the flow in the passageway 1002. The turbulence transition mode can be calculated according to any aspects of the presently disclosed turbulence control model. The controller 1090 can, in some instances, calculate or adjust the calculation of the turbulence transition mode based on information received from the motors 1013 or the sensors 1012. The sensors 1012 can be disposed within the conduit 1002 (as shown), on or about an external portion of the conduit, or otherwise associated with the conduit 1001 such that measurements or observations of information indicative of the fluid flow in the conduit can be received and provided to the controller 1090 for use in, for example, adjusting the generated flow disturbances and/or adjusting the calculated turbulence transition mode. In operation, a fluid flowing through the passageway 1002 of the conduit 1001 can be acted upon by the interior portion 1009 and thereby can be able to achieve, for example, a high flow rate without having the fluid flow transition to turbulence.

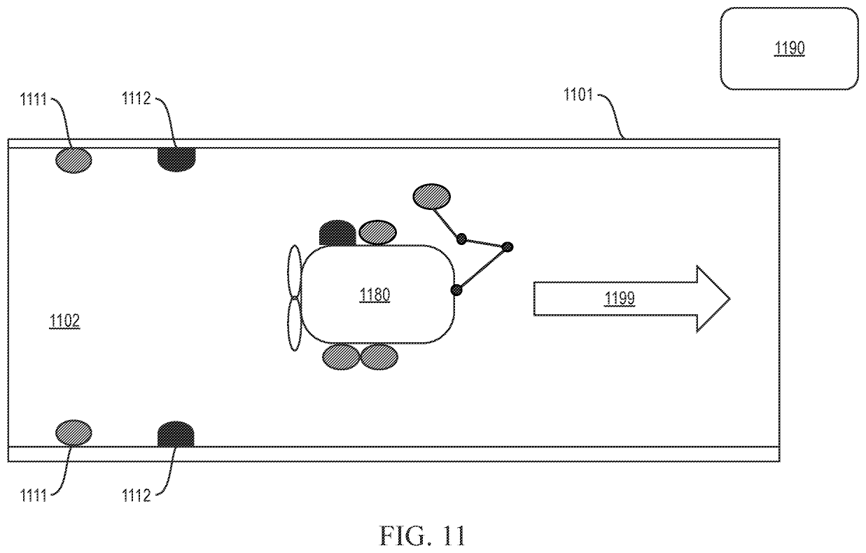

Another example of the present disclosure is a system for modifying conduits to include any of the flow control devices, structures, etc. disclose herein. FIG. 11 is a schematic side cross-sectional view of a conduit 1101 with a remote device 1180 traveling (as indicated by arrow 1199) in a passageway 1102 of the conduit 1101 that is modifying an inner surface of the conduit 1101 to include active turbulence control devices 1111 and fluid property sensors 1112, either of which can be configured to commutate with a controller 1190 that can be located near the conduit 1101 or elsewhere. Additionally, any and all of the previous teachings and understandings related to other examples presented herein are applicable to this embodiment.

### Detailed Physical Picture of the Turbulence Transition

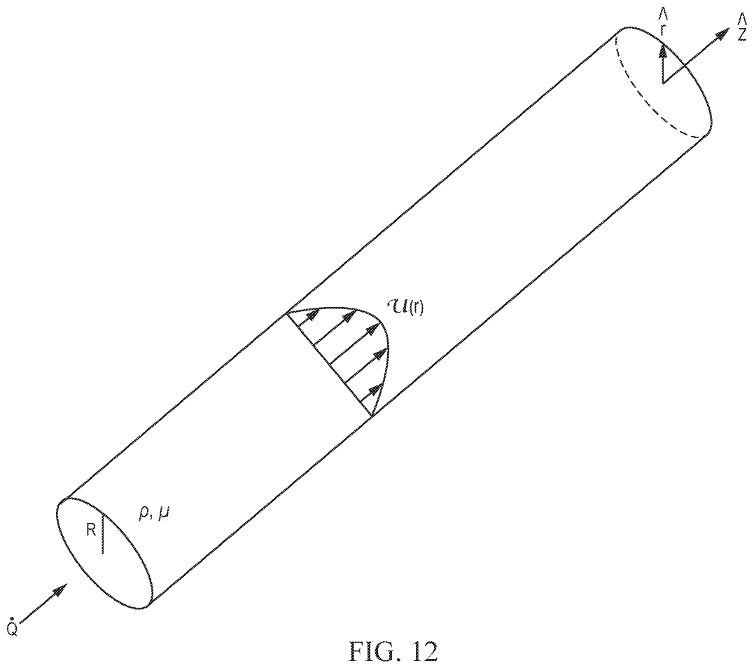

This section details the physical picture for transitioning fluid flow through a straight circular pipe of diameter D=2R from laminar to turbulent, as shown in FIG. 12. This transition has been measured experimentally in the literature, where results were obtained by introducing a precision disturbance into a fully developed and time-independent laminar flow. The flow is then observed many pipe diameters downstream where the first instance of a discrete turbulent “puff” marks the transition boundary between disturbances that relaminarize and those that persist. The turbulent puff has been observed experimentally to be about five to ten pipe diameters long, surrounded by laminar flow upstream and downstream, and travelling at approximately the flow's mean speed U. The fluid is considered incompressible and Newtonian, that is, prescribed by its density ρ and viscosity u (or equivalently v=μ/ρ), and the flow is characterized by its pressure gradient

$$\frac{δ P}{δ z}$$

and volume flow rate \dot{Q} (or equivalently Ū). These quantities in addition to the details of the method of flow disturbance disclosed herein, define the transition.

The laminar flow through a pipe is given in cylindrical coordinates r=(r, φ, z) by

$$\begin{matrix}U = 2 \overline{U} ( 1 - \frac{{r}^{2}}{{R}^{2}} ) \hat{z} \\ for : \overline{U} = - \frac{{R}^{2}}{δμ} \frac{\partial P}{\partial z} \dot{Q} = π {R}^{2} \overline{U}\end{matrix} \qquad ( Equation 7 )$$

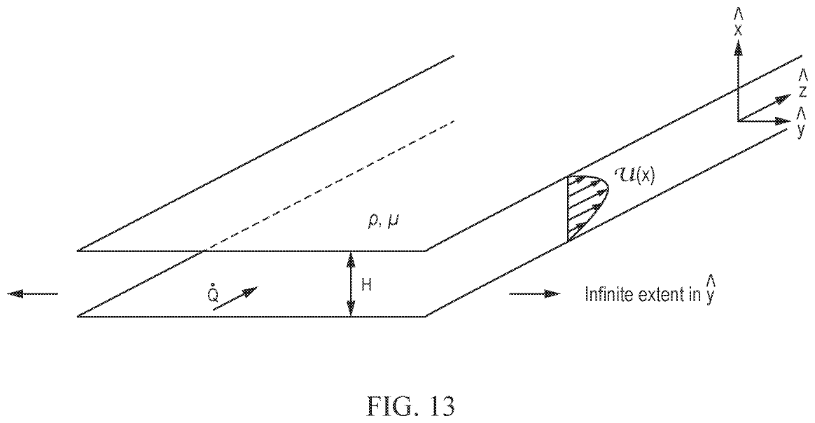

For completeness, the analogous Couette flow between parallel plates separated by a distance H, as shown in FIG. 13, in Cartesian coordinates is

$$\begin{matrix}U = \frac{3}{2} \overline{U} ( 1 - 4 \frac{{x}^{2}}{{H}^{2}} ) \hat{z} \\ for : \overline{U} = - \frac{{H}^{2}}{12 μ} \frac{\partial P}{\partial z} \dot{Q} = \overline{U} H .\end{matrix} \qquad ( Equation 8 )$$

### Mechanism of Turbulence Development

The mechanism of development for a self-sustaining turbulent puff utilized in the turbulence model disclosed herein is now described. Given an arbitrary radial displacement of a portion of the laminar flow, for instance radially inward, the streamwise velocity of the displaced fluid particle can then be smaller than the local background flow due its velocity gradient, as prescribed by Equation 1 above. The radial component of flow disturbance is special in this regard because the \hat{ϕ} and \hat{z} components do not traverse the laminar flow field gradient. This evolves the radial disturbance in two important ways. First, the fluid particle is convected forward, which leads to transient amplification of the disturbance in the streamwise direction before viscous decay (e.g., the fluid particle attains the velocity of the local background flow). This amplification can be quite significant for large flow rates. Second, the radial disturbance may act to pin the concentric vortex line rings present in the laminar flow field. This causes a backward stretching of the vortex lines, which may in turn develop into a pair of counter-rotating streamwise vortices. These vortices transport fluid across the laminar flow gradient in both directions, manifesting low/high speed streamwise streaks near the center/outer locations of the pipe's cross section respectively. Transient amplification again occurs in the streaks, further contributing to the counter-rotating vortices and rendering the disturbance flow field self-sustaining as a whole. The same situation results if starting with an initial radially outward fluid displacement, but with the sign of the counter-rotating vortices reversed; the locations of the low/high speed streamwise streaks, however, remain the same either way.

Due to the cylindrical geometry of a pipe, the low speed streaks near the center of the pipe are closer in proximity to one another than the high-speed streaks near the circumference of the pipe. This may lead to merging of neighboring low speed streaks, and this can likely be because it would serve to lower the total viscous dissipation of the disturbance flow field. The simplest case is pair-wise merging, where one would expect to find n low speed streaks near the pipe's center and 2n high speed streaks near the pipe's circumference, where the integer n depends on (and presumably increases with) the Reynolds number

$$Re ≡ \frac{R \overline{U}}{v} .$$

This mechanism appears to be in agreement with the disturbance flow fields measured experimentally within sustained turbulent puffs.

The counter-rotating vortices themselves, however, are unstable and may develop instabilities with respect to the cross section of the vortex core (e.g., elliptic instabilities) as well as the streamwise path of the vortex core (e.g., crow instabilities), which have respective wavelengths on the order of Δₚ˜d_{c} and Δₚ˜5−10d_{c}, where d_{c} is the diameter of the vortex core. Both of these wavelengths appear to be present experimentally, where the latter influences the length of the turbulent puff. Here, the path wavelength λₚ develops in-phase for each counter-rotating vortex pair, and may grow in amplitude until the vortex cores intersect, resulting in the streamwise vortex cores pinching off into vortex rings. These vortex rings have streamwise length λₚ, and serve to partition the disturbance flow field into discrete segments. By inspection, d_{c} is a fraction of the pipe radius R, so Δₚ˜a few R.

It can be important to keep in mind that the vortex structure described above is only observed through near-instantaneous experimental measurements of the disturbance flow field. Over longer times, the flow can appear highly chaotic and with a cascade of turbulent eddy length scales spanning from l˜D to a small-scale viscous cutoff at

$$Re ∼ 1 ⇒ {l}_{v} ∼ \frac{v}{\overline{U}} .$$

This suggests conceptualizing the flow behavior inside a puff as a continuous death and rebirth of streamwise vortex structures, which can manifest only briefly before being obscured by turbulent shedding. This physical picture strongly suggests categorizing the turbulent state as a strange attractor, which is viewpoint arrived at through chaos theory and statistical methods. Clearly, this route to sustained turbulence is nonlinear and requires an initial displacement with sufficient finite amplitude to establish. If insufficient, the formation of counter-rotating vortex pairs will be too weak to turn over enough fluid into the low/high speed streaks to experience significant transient growth, resulting ultimately in viscous decay and relaminarization.

The energy to sustain the puff can be supplied by the laminar background flow. As a simple magnitude estimate, we can compare the laminar flow field to a time-averaged turbulent flow, which is nearly uniform across the cross-section of the pipe. This yields a relative change in the velocity field:

$$Δ U = U - \overline{U} = \overline{U} ( 1 - \frac{2 {r}^{2}}{{R}^{2}} ) \qquad ( Equation 9 )$$

and corresponding average kinetic energy density (per unit mass):

$$〈 {( Δ U )}^{2} 〉 = \frac{2 π}{π {R}^{2}} {\int }_{0}^{R} {( Δ U )}^{2} rd r = \frac{1}{3} {\overline{U}}^{2} \qquad ( Equation 10 )$$

Equation 10 represents the energy available to “feed into” the puff at its upstream boundary. A sustained turbulent puff balances this energy input with its viscous dissipation. For smaller Re (Reynolds number), viscous dissipation dominates and the puff ultimately relaminarizes. For larger Reynolds number, the puff grows in length and may occasionally split in two, both obtaining a sustained configuration separated by an intermediate laminar region.

This behavior can be rationalized in light of the above mathematical picture. For a turbulent patch of length ≥Δₚ, vortex pinch off locations will develop with period≈ₚ. Immediately proceeding pinch off, the loop ends may locally be viewed as a counter-rotating vortex pair aligned with the cross-sectional plane of the pipe. This orientation tends to enhance turbulent shedding and disintegrate the vortex core, resulting in a region of elevated viscous dissipation without the same transient growth mechanism described for streamwise vortices. Consequently, the pinch off region may relaminarize and separate regions of sustained turbulence. Mechanistically, the enhanced turbulence at the loop ends provides radial displacements in the flow that may contribute to transient growth and streamwise vortices downstream, but not upstream (e.g., the upstream portion of the puff experiences only viscous decay in the neighborhood of the pinch off region, while the portion that separates downstream may experience transient growth).

The minimum steady-state length of an intermediate laminar region between puffs is determined by the degree of laminar development required at the boundary with the downstream puff for it to self-sustain. It is easy to see that this length may be smaller at larger Re. Conversely, decreasing Re from within the turbulent state-space approaches a transition boundary for sustained puffs, where the laminar flow profile must approach the limit of full development (see Equation 7), and therefore formally be of infinite length. This agrees with experimental observations where, at the transition boundary, turbulent puffs first appear infrequently and separated by arbitrarily large distances. For increasing Re, the puffs occur more frequently and with closer spacing. At close proximity, the puffs interact with one another in a complicated manner, splitting and merging, until ultimately the entire flow becomes uniformly turbulent.

### Scaling

In light of the previous section, the neutrally stable mode marking the turbulence transition corresponds to a balance between the viscous and nonlinear terms in the Navier-Stokes equations (Equation 1a), which yields the scaling

$$μ \frac{{u}^{2}}{{R}^{2}} ∼ ρ \frac{{u}^{3}}{R} ,$$

or more simply

$$\frac{u}{\overline{U}} ∼ \frac{1}{Re} .$$

Assuming an appropriate proportional coefficient is included in the definition of u, Equation 11 is established:

$$\frac{u}{\overline{U}} ∼ \frac{1}{Re} \qquad ( Equation 11 )$$

Equation 11 can be interpreted as the condition a disturbance field imparted onto the laminar flow must satisfy to trigger sustained turbulence at a given Re. As discussed in the Mechanisms of Turbulence Development section above, turbulence first appears as a discrete sustained “puff” that convects downstream, fed by the laminar flow at its upstream boundary. This case corresponds to u˜Ū, provided there are no other mechanisms of flow disturbance, yielding Equation 12 (for a constant c):

$$Re = c \qquad ( Equation 12 )$$

The Equations 11 and 12 together define the transition boundary. Said differently, Equation 12 represents the threshold for which the kinetic energy fed from the laminar base flow into the puff is sufficient to balance the viscous dissipation of the puff, while the disturbance amplitude required initially to trigger turbulence is given by Equation 11. There is an additional simple interpretation for Equation 11 found by cancelling Ū on both sides so this is reads

$$u ∼ \frac{v}{R} .$$

This indicates a matching of speeds characteristic for the disturbance u and for viscous diffusion. Evidently triggering turbulence requires disturbances

$$u ≳ \frac{v}{R} ,$$

which implies, in some averaged sense, that the propagation of the disturbance leads in front of the envelope of viscous decay, providing an opportunity for redistribution of kinetic energy without dissipation. Conversely,

$$u ≲ \frac{v}{R}$$

implies that the propagation of the disturbance trails inside the envelope of viscous decay, rendering the motion dissipative as a whole, which ultimately leads to relaminarization. This same discussion applies to Equation 12, taking u→U.

Generally, the turbulent state comprises a cascade of lengthscales spanning many orders of magnitude, from which a near infinity of pseudomodes may be constructed. The situation at the transition boundary, however, is considerably simplified. It is natural to postulate that the pseudomode with the longest wavelength (e.g., smallest wave vector) is primarily responsible for the transition, as this particular one experiences the least viscous dissipation and therefore persists with finite amplitude for the greatest time, over which energy may be transferred to the eigenstates allowed by certain selection rules arising from the nonlinear term in Equation 1A. The wavelength for this pseudomode is fixed by the geometry of the pipe, regardless of Re. Since the nonlinear term is quadratic (see Equation 1A), and keeping in mind the azimuthal and axial symmetry of the pipe, energy exchange primarily occurs between wavelengths differing by a factor of two (2). Additionally, the nonlinear term mixes vector components of all coordinate directions, which implies that the wavelengths allowed by the selection rule are commensurate with respect to both the cross-section of the pipe and the streamwise direction. The longest wavelengths satisfying this condition are λ=2R, 4R corresponding to the cross-section and streamwise directions respectively. Thus, a pseudomode with wavevector

$${k}_{0} = \frac{2 π}{4 R}$$

(I.e., wavelength λ₀=4R) exchanging energy with an eigenmode with wavevector

$${k}_{α} = \frac{2 π}{2 R}$$

(i.e., wavelength λₐ=2R) can be considered. The pseudomode convects downstream with corresponding frequency k₀Ū, which yields a time-dependent disturbance amplitude of the form of Equation 14:

$$u = {u}_{0} {k}_{0} \overline{U} {te}^{- {k}_{0} \overline{U} t} {e}^{{ik}_{0} \overline{U} t} Θ ( {k}_{0} \overline{U} t ) \qquad ( Equation 13 )$$

In Equation 13, u₀ represents an initial displacement amplitude, and the Heaviside step function Θ(kₚŪt) ensures only times t>0 subsequent the initial displacement are considered. One can arrive at this functional form through a simple physical argument: a disturbance oscillating with wavelength do experiences an initial period of transient growth, which is linear with respect to time due to convection by the laminar base flow, followed by exponential viscous decay. Taking a Fourier transformation of Equation 13 with respect to time (e.g., F[u(t)]=û (ω)), and taking its absolute value yields a corresponding frequency response function R₀(ω)=|û(ω)|, which can be recast in terms of normalized wave vectors by substituting ω→k, for k measured in units of the pipe radius R. Taking into account the normalization ∫_{-∞}^{∞}R₀(κ)dκ=1 yields the final result of Equation 5, presented above and here again:

$${R}_{0} ( k ) = \frac{1}{π} \frac{1}{{( k - {k}_{0} )}^{2} + 1} \qquad ( Equation 5 )$$

The net excitation amplitude of the eigenstate uₐ due to an external disturbance spectrum spectrum u_{δ}(K), mediated by energy transfer via the pseudomode, is then given by Equation 4, presented above and here again:

$$u = {\int }_{- ∞}^{∞} {R}_{0} ( {k0u}_{δ} ( k ) dk = \frac{1}{π} {\int }_{- ∞}^{∞} \frac{{u}_{δ} ( k ) dk}{{( k - {k}_{0} )}^{2} + 1} \qquad ( Equation 4 )$$

where

$${k}_{0} = \frac{π}{2} .$$

This expression gives the amplitude u for use in Equation 11. The eigenstates of the perturbed flow are what manifest physically, and all experimental measurements of a velocity field of a puff so far have found λₐ=2R, within measurement error. This, alongside the data collapses summarized elsewhere herein, establishes the validity of the presently disclosed model and postulate.

The systems and methods described herein can be implemented in hardware, software, firmware, or combinations of hardware, software and/or firmware. In some examples, the systems and methods described in this specification may be implemented using a non-transitory computer readable medium storing computer executable instructions that when executed by one or more processors of a computer cause the computer to perform operations. Computer readable media suitable for implementing the systems and methods described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a system or method described in this specification may be located on a single device or computing platform or may be distributed across multiple devices or computing platforms.

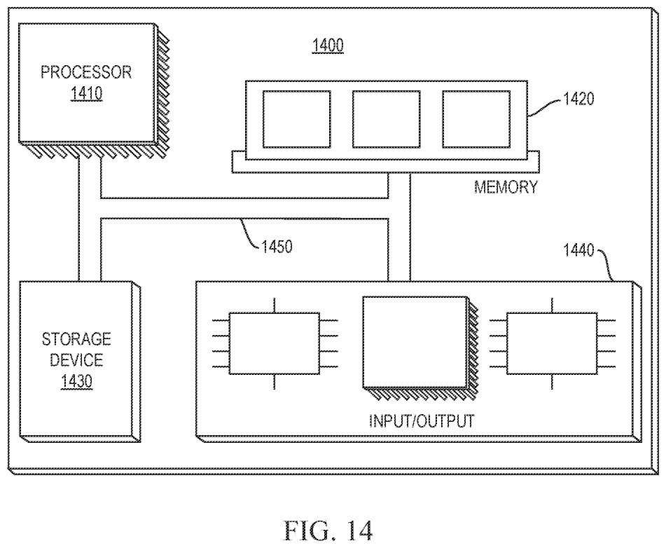

FIG. 14 provides for one non-limiting example of a computer system 1400 upon which the present disclosure can be built, performed, trained, etc. For example, referring to FIGS. 5, 9, 10, and 11, the processing modules or processors 590, 990, 1090, 1190 can be examples of the system 1400 described herein. The system 1400 can include a processor 1410, a memory 1420, a storage device 1430, and an input/output device 1440. Each of the components 1410, 1420, 1430, and 1440 can be interconnected, for example, using a system bus 1450. The processor 1410 can be capable of processing instructions for execution within the system 1400. The processor 1410 can be a single-threaded processor, a multi-threaded processor, or similar device. The processor 1410 can be capable of processing instructions stored in the memory 1420 or on the storage device 1430. The processor 1410 may execute operations such as calculation of a turbulence transition mode, calculation of a flow disturbance to suppress a turbulence transition mode, or adjustment of a predicted turbulence transition mode based on information received from one or more sensors measuring a fluid flow, among other features described in conjunction with the present disclosure, including any control logic associated with the operation of an active turbulence suppression system or device.

The memory 1420 can store information within the system 1400. In some implementations, the memory 1420 can be a computer-readable medium. The memory 1420 can, for example, be a volatile memory unit or a non-volatile memory unit. In some implementations, the memory 1420 can store information related conduit geometries, fluid flow parameters (predicted or measured), turbulence transition mode(s), any information related to the calculation of the turbulence transition mode, among other information.

The storage device 1430 can be capable of providing mass storage for the system 1400. In some implementations, the storage device 1030 can be a non-transitory computer-readable medium. The storage device 1430 can include, for example, a hard disk device, an optical disk device, a solid-date drive, a flash drive, magnetic tape, or some other large capacity storage device. The storage device 1430 may alternatively be a cloud storage device, e.g., a logical storage device including multiple physical storage devices distributed on a network and accessed using a network. In some implementations, the information stored on the memory 1420 can also or instead be stored on the storage device 1430.

The input/output device 1440 can provide input/output operations for the system 1400. In some implementations, the input/output device 1440 can include one or more of network interface devices (e.g., an Ethernet card), a serial communication device (e.g., an RS-232 10 port), and/or a wireless interface device (e.g., a short-range wireless communication device, an 802.11 card, a 3G wireless modem, or a 4G wireless modem). In some implementations, the input/output device 1440 can include driver devices configured to receive input data and send output data to other input/output devices, e.g., a keyboard, a printer, and display devices. In some implementations, mobile computing devices, mobile communication devices, and other devices can be used.

In some implementations, the system 1400 can be a microcontroller. A microcontroller is a device that contains multiple elements of a computer system in a single electronics package. For example, the single electronics package could contain the processor 1410, the memory 1420, the storage device 1430, and input/output devices 1440.

Although an example processing system has been described above, implementations of the subject matter and the functional operations described above can be implemented in other types of digital electronic circuitry, or in computer software, firmware, and/or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink-wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud-computing model. Of course, some embodiments of the present disclosure may be implemented as a combination of both software (e.g., a computer program product) and hardware. Still other embodiments of the present disclosure are implemented as entirely hardware, or entirely software.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

Examples of the present disclosure include:
1. A system for controlling turbulence in a fluid flow in a conduit, the system comprising:
   a conduit configured to have therein a fluid flow; and
   at least one device associated or integrated with the conduit and configured to generate a disturbance in a fluid flow in the conduit to suppress a calculated turbulence transition mode of the fluid flow.
2. The system of any of the examples herein, wherein the turbulence transition mode was calculated based on a turbulence model using a geometry of the conduit and one or more properties of the fluid and further by calculating, according to the turbulence model, at least one response function (Rᵢ(k)) and an excitement amplitude (uₖᵢ) for each response function.
3. The system of any of the examples herein, wherein the turbulence transition mode was calculated according to Equation 12 and the generated disturbance was calculated as a function of Equation 4.
4. The system of any of the examples herein, wherein the conduit comprises a pipe or channel.
5. The system of any of the examples herein, wherein the at least device includes an active flow disturbance device, the system further comprising:
   a controller configured to command the active flow disturbance device,
   wherein the active flow disturbance device is configured to modify flow parameters of the fluid flow in the conduit in response to the controller, and
   wherein the controller is configured to generate commands based on the calculated turbulence transition mode.
6. The system of any of the examples herein, further comprising:
   at least one sensor configured to measure one or more properties of the fluid flow in the conduit related to the transition between laminar and turbulence flow,
   wherein the controller is further configured to generate the commands based on the measured properties.
7. The system of any of the examples herein, wherein the controller is configured to at least one of calculate or adjust the calculation of the turbulence transition mode or an amplification response function for the turbulence transition mode for the fluid flow in the conduit based on the measured properties.
8. The system of any of the examples herein, wherein the at least one device comprises an inner surface of the conduit.
9. The system of any of the examples herein, wherein the inner surface comprises a deformable material configured to absorb energy from the calculated turbulence transition mode in the fluid flow.
10. The system of any of the examples herein, wherein the at least one device comprises a vibration-inducing device arranged to introduce vibrational energy into the fluid flow to suppress the calculated turbulence transition mode.
11. A method of controlling fluid flow in a conduit, the method comprising:
   adjusting a flow of a fluid through a conduit to reduce turbulence therein based on a determined turbulence transition mode.
12. The method of any of the examples herein, further comprising determining the turbulence transition mode based on a turbulence model as a function of a geometry of the conduit and one or more properties of the fluid and further by calculating, according to the turbulence model, at least one response function (Rᵢ(k)) and an excitement amplitude (uₖᵢ) for each response function.
13. The method of any of the examples herein, further comprising calculating the turbulence according to Equation 12 and calculating the adjusting of the flow as a function of Equation 4.
14. The method of any of the examples herein, wherein adjusting the flow of the fluid comprises selectively absorbing energy from the fluid at or about the calculated turbulence transition mode of the fluid flow.
15. The method of any of the examples herein, wherein adjusting the flow of the fluid comprises actuating an active flow control device configured to generate a disturbance in a fluid flow in the conduit to suppress a calculated turbulence transition mode of the fluid flow
16. The method of any of the examples herein, including adjusting the flow of the fluid with at least one device associated or integrated with the conduit and wherein adjusting the flow of the fluid comprises introducing to the fluid flow or extracting energy from the fluid flow.
17. The method of any of the examples herein, further comprising:
   sensing at least one property of the fluid flow in the conduit related to the transition between laminar and turbulence flow; and
   adjusting the flow of the fluid with the at least one device based on the sensed at least one property.
18. The method of any of the examples herein, further comprising calculating or adjusting the calculation of the turbulence transition mode for the fluid flow in the conduit based on the sensed at least one property, and wherein adjusting the flow of the fluid with the at least one device is further based on the calculated or adjusted turbulence transition mode.
19. The method of any of the examples herein, comprising:
   modifying the conduit by changing a property of an interior surface of the conduit or associating at least one device with the conduit, the at least one device or modified interior surface being configured to adjust the flow of the fluid in the conduit to suppress a calculated turbulence transition mode of the fluid flow.
20. A method of reducing turbulence in a fluid flow in a conduit, the method comprising:
   given a fluid flow through a conduit, generating a disturbance in the fluid flow in the conduit to suppress a calculated turbulence transition mode of the fluid flow.
21. A turbulence control system for a conduit, comprising at least one modification that includes at least one of an active, a reactive, or a passive turbulence control system configured to prevent, absorb, or suppress a calculated turbulence transition mode of a fluid flow in the conduit.
22. The turbulence control system of any of the examples herein, wherein the turbulence control system includes at least one of: (a) vibration-inducing devices configured to disturb fluid flow in the conduit to suppress the calculated turbulence transition mode, (b) textured surfaces disposed on an inner surface of the conduit, (c) modified cross-section or cross-sectional structures of the conduit, (d) liners on an inner surface of the conduit configured to preferentially absorb energy from the fluid flow at the calculated turbulence transition mode, (e) coatings or surface finishes on the inner surface of the conduit; or (f) conduit flexibility/deformation; wherein the one or more pipe modifications are installed in a manner that absorbs or suppresses the calculated turbulence transition mode of a fluid or gas within the pipe or channel.
23. The turbulence control system of any of the examples herein, wherein conduit flexibility/deformation the pipe or material therein absorbs energy from the transition mode of the fluid or gas within the pipe or channel.
24. The turbulence control system of any of the examples herein, wherein the vibration-inducing devices are mounted to the interior or exterior surfaces of the pipe or channel or within the thickness of the wall of the conduit to impart perturbations to the fluid or gas within the pipe or channel.
25. The turbulence control system of any of the examples herein, wherein the modification alters the stream wise wavelength or cross-section of the pipe or channel so that the pipe or channel is incommensurate with developing the transition mode of the fluid or gas within the conduit according to the predicted turbulence transition mode.
26. The turbulence control system of any of the examples herein, wherein the modification comprises vibration absorbing materials lining the interior of the pipe or channel, the vibration absorbing materials configured to preferentially absorb energy from a fluid flow in the conduit at the calculated turbulence transition mode.
27. The turbulence control system of any of the examples herein, further including a inspection gauge or tool for the pipe or channel configured to travel through existing pipelines or channel lines and retrofit them from the interior of the pipe or channel by adding an active, passive, or reactive system for turbulence suppression of the fluid or gas within the pipe or channel.
28. The turbulence control system of any of the examples herein, further including manufacture of new conduits integrated with turbulence suppression system.
29. The turbulence control system of any of the examples herein, further including on-construction-site modifications/retrofits of pipes or channels for turbulence suppression of the fluid or gas within the conduit.

The embodiments of the present disclosure described above are intended to be merely exemplary; numerous variations and modifications will be apparent to those skilled in the art. One skilled in the art will appreciate further features and advantages of the disclosure based on the above-described embodiments. Such variations and modifications are intended to be within the scope of the present invention as defined by any of the appended claims. Accordingly, the disclosure is not to be limited by what has been particularly shown and described, except as indicated by the appended claims. All publications and references cited herein are expressly incorporated herein by reference in their entirety.

What is claimed is:

1. A system for controlling turbulence in a fluid flow in a conduit, the system comprising:
a conduit configured to have therein a fluid flow; and
at least one device associated or integrated with the conduit and configured to generate a disturbance in a fluid flow in the conduit to suppress a calculated turbulence transition mode of the fluid flow.

2. The system of claim 1, wherein the turbulence transition mode was calculated based on a turbulence model using a geometry of the conduit and one or more properties of the fluid and further by calculating, according to the turbulence model, at least one response function (Rᵢ(k)) and an excitement amplitude (uₖᵢ) for each response function.

3. The system of claim 2, wherein the turbulence transition mode was calculated according to Equation 12 and the generated disturbance was calculated as a function of Equation 4.

4. The system of claim 1, wherein the conduit comprises a pipe or channel.

5. The system of claim 1, wherein the at least device includes an active flow disturbance device, the system further comprising:
a controller configured to command the active flow disturbance device,
wherein the active flow disturbance device is configured to modify flow parameters of the fluid flow in the conduit in response to the controller, and
wherein the controller is configured to generate commands based on the calculated turbulence transition mode.

6. The system of claim 5, further comprising:
at least one sensor configured to measure one or more properties of the fluid flow in the conduit related to the transition between laminar and turbulence flow,
wherein the controller is further configured to generate the commands based on the measured properties.

7. The system of claim 6, wherein the controller is configured to at least one of calculate or adjust the calculation of the turbulence transition mode or an amplification response function for the turbulence transition mode for the fluid flow in the conduit based on the measured properties.

8. The system of claim 1, wherein the at least one device comprises an inner surface of the conduit.

9. The system of claim 1, wherein the inner surface comprises a deformable material configured to absorb energy from the calculated turbulence transition mode in the fluid flow.

10. The system of claim 1, wherein the at least one device comprises a vibration-inducing device arranged to introduce vibrational energy into the fluid flow to suppress the calculated turbulence transition mode.

11. A method of controlling fluid flow in a conduit, the method comprising:
adjusting a flow of a fluid through a conduit to reduce turbulence therein based on a determined turbulence transition mode.

12. The method of claim 11, further comprising determining the turbulence transition mode based on a turbulence model as a function of a geometry of the conduit and one or more properties of the fluid and further by calculating, according to the turbulence model, at least one response function (Rᵢ(k)) and an excitement amplitude (uₖᵢ) for each response function.

13. The method of claim 12, further comprising calculating the turbulence according to Equation 12 and calculating the adjusting of the flow as a function of Equation 4.

14. The method of claim 11, wherein adjusting the flow of the fluid comprises selectively absorbing energy from the fluid at or about the calculated turbulence transition mode of the fluid flow.

15. The method of claim 11, wherein adjusting the flow of the fluid comprises actuating an active flow control device configured to generate a disturbance in a fluid flow in the conduit to suppress a calculated turbulence transition mode of the fluid flow

16. The method of claim 11, including adjusting the flow of the fluid with at least one device associated or integrated with the conduit and wherein adjusting the flow of the fluid comprises introducing to the fluid flow or extracting energy from the fluid flow.

17. The method of claim 16, further comprising:
sensing at least one property of the fluid flow in the conduit related to the transition between laminar and turbulence flow; and
adjusting the flow of the fluid with the at least one device based on the sensed at least one property.

18. The method of claim 11, further comprising calculating or adjusting the calculation of the turbulence transition mode for the fluid flow in the conduit based on the sensed at least one property, and wherein adjusting the flow of the fluid with the at least one device is further based on the calculated or adjusted turbulence transition mode.

19. The method of claim 11 comprising:
modifying the conduit by changing a property of an interior surface of the conduit or associating at least one device with the conduit, the at least one device or modified interior surface being configured to adjust the flow of the fluid in the conduit to suppress a calculated turbulence transition mode of the fluid flow.

20. A method of reducing turbulence in a fluid flow in a conduit, the method comprising:
given a fluid flow through a conduit, generating a disturbance in the fluid flow in the conduit to suppress a calculated turbulence transition mode of the fluid flow.
